(19) United States
(12) Patent Application Publication
(10) Pub. No.: US 2012/0274980 A1
(43) Pub. Date: Nov. 1, 2012

(54) INFORMATION PROCESSING SYSTEM FOR REDUCING LOAD ON A SERVER APPARATUS

(75) Inventor: Hiroaki Koike, Kokubunji-shi (JP)

(73) Assignee: CANON KABUSHIKI KAISHA, Tokyo (JP)

(21) Appl. No.: 13/449,050

(22) Filed: Apr. 17, 2012

(30) Foreign Application Priority Data
Apr. 26, 2011 (JP) 2011-098527

(51) Int. Cl. G06F 3/12; G06K 15/02

(52) U.S. Cl. 358/1.15

(57) ABSTRACT

In a system in which a web server provides an operation screen related to cooperative processing, forcing the web server to generate all of operation screens in consideration of an MFP as a cooperation destination for the cooperative processing may increase the load on the web server. Therefore, when a specific condition is satisfied, for example, when an error has occurred in the MFP as a cooperation destination for the cooperative processing or when a specific function is used as cooperative processing, not the web server but the MFP as a cooperation destination for the cooperative processing provides an MFP with an operation screen related to the cooperative processing.

### BACKGROUND OF THE INVENTION

1. Field of the Invention

The present invention relates to an information processing system.

2. Description of the Related Art

It is known that an information processing apparatus such as a personal computer (PC) is connected with a web server on a network, and an operation screen provided by the web server is displayed on a web browser included in the information processing apparatus.

In this case, the web browser of the information processing apparatus requests the web server for the operation screen. In response to the request from the information processing apparatus, a web application on the web server transmits to the information processing apparatus a Hyper Text Markup Language (HTML) file for displaying the operation screen on the web browser. The web browser of the information processing apparatus analyzes the received HTML file, and displays the operation screen based on the descriptions of the HTML file.

When a user inputs an instruction by using the operation screen displayed on the web browser, the web browser notifies the web server of the input instruction. Upon reception of the notification, the web application on the web server performs necessary processing according to the instruction.

These days some multifunction peripherals (MFPs) provided with a scanner and a printer are also provided with the above-mentioned web browser. Such an MFP displays on its web browser an operation screen provided by the web server through the above-mentioned procedures, and receives various instructions from a user.

The web browser of the MFP notifies the web server of an instruction input in the operation screen by the user. Upon reception of the notification, the web server requests the MFP to perform various processing according to the instruction input by the user. Then, upon reception of the request, the MFP performs the requested processing.

This makes it unnecessary for the MFP to store all menu data for operating the MFP. When menu data needs to be changed, it is only necessary to make changes within the web server.

As an extended version of this technique, Japanese Patent Application Laid-Open No. 2006-203870 discusses a technique for causing a plurality of MFPs to cooperatively process a single job.

As an example of cooperative processing discussed in Japanese Patent Application Laid-Open No. 2006-203870, suppose a case where a user instructs a remote copy job with which a first MFP transmits image data (generated by scanning a document) to a second MFP as a cooperation destination which then prints the image data.

The user instructs the remote copy job by using the operation screen provided by the web server displayed on the first MFP. In this case, the web server needs to generate an operation screen in consideration of the status of the second MFP (for example, apparatus configuration, executable functions, and existence of errors) and provide the first MFP with the generated operation screen.

However, since cooperation destination MFPs for cooperative processing are MFPs of various models, executable functions differs according to whether or not options are installed even for an identical model. Further, types of errors occurring in cooperation destination MFPs for cooperative processing differ according to the model and apparatus configuration of the MFPs.

Therefore, forcing the web server to generate an operation screen in consideration of the status of each individual MFP as a cooperation destination for cooperative processing may increase the load on the web server.

### SUMMARY OF THE INVENTION

The present invention is directed to reducing the load on a server apparatus by suitably determining whether an operation screen related to cooperative processing is to be generated by the server apparatus or by a cooperation destination information processing apparatus for cooperative processing.

According to an aspect of the present invention, an information processing system includes a server apparatus, a first information processing apparatus, and a second information processing apparatus, wherein the first and the second information processing apparatuses cooperate with each other to achieve cooperative processing for processing a job, wherein the server apparatus includes a first transmission unit configured to transmit an operation screen related to the cooperative processing to the first information processing apparatus, wherein the second information processing apparatus includes a second transmission unit configured to transmit an operation screen related to the cooperative processing to the first information processing apparatus, and wherein the server apparatus further includes a determination unit configured to, when the server apparatus receives a request for the operation screen related to the cooperative processing from the first information processing apparatus, determine which of the server apparatus and the second information processing apparatus is to transmit the operation screen related to the cooperative processing to the first information processing apparatus, by making an inquiry to the second information processing apparatus.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates an overall configuration of an information processing system according to an exemplary embodiment of the present invention.

FIGS. 2A and 2B are block diagrams illustrating hardware configurations of MFPs according to the exemplary embodiment of the present invention.

FIG. 3 is a block diagram illustrating a configuration of a web server according to the exemplary embodiment of the present invention.

FIG. 4 is a block diagram illustrating a software configuration of the entire information processing system according to the exemplary embodiment of the present invention.

FIGS. 5A, 5B, and 5C are sequence diagrams illustrating processing performed between the MFPs and the web server according to a first exemplary embodiment of the present invention.

FIGS. 6A, 6B, and 6C illustrate examples of operation screens according to the first exemplary embodiment of the present invention.

FIG. 7 illustrates redirection information according to the first exemplary embodiment of the present invention.

FIG. 8 is a flowchart illustrating processing performed by the web server according to the first exemplary embodiment of the present invention.

FIG. 9 is a flowchart illustrating processing performed by the MFPs according to the first exemplary embodiment of the present invention.

FIG. 10 is a flowchart illustrating processing performed by the web server according to a second exemplary embodiment of the present invention.

FIG. 11 illustrates redirection information according to the second exemplary embodiment of the present invention.

FIG. 12 illustrates an example of an operation screen according to the second exemplary embodiment of the present invention.

### DESCRIPTION OF THE EMBODIMENTS

Various exemplary embodiments, features, and aspects of the invention will be described in detail below with reference to the drawings.

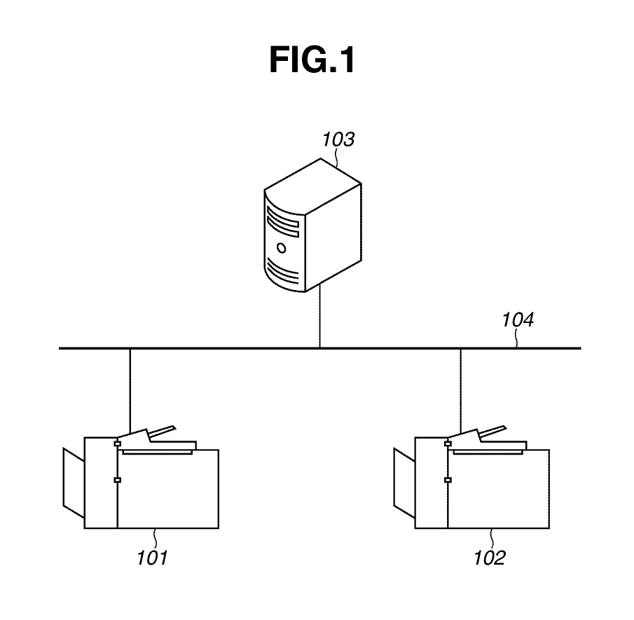

FIG. 1 illustrates an overall configuration of an image processing system according to the present exemplary embodiment.

An MFP 101, an MFP 102, and a web server 103 are connected to a local area network (LAN) 104 to enable communication therebetween. The connection form of the MFP 101, the MFP 102, and the web server 103 is not limited to a LAN. The image processing system according to the present invention can be achieved via the Internet, a wireless communication method, and any other connection methods.

Although, in the present invention, an MFP serves as an information processing apparatus, the information processing apparatus is not limited thereto, and may be a single function peripheral (SFP) such as a scanner and a printer, or a personal computer (PC).

Although, in the present invention, a web server serves as a server apparatus, an external apparatus is not limited thereto, and may be an MFP or a PC having web server functions. The MFPs 101 and 102 can perform cooperative processing which will be described in detail below.

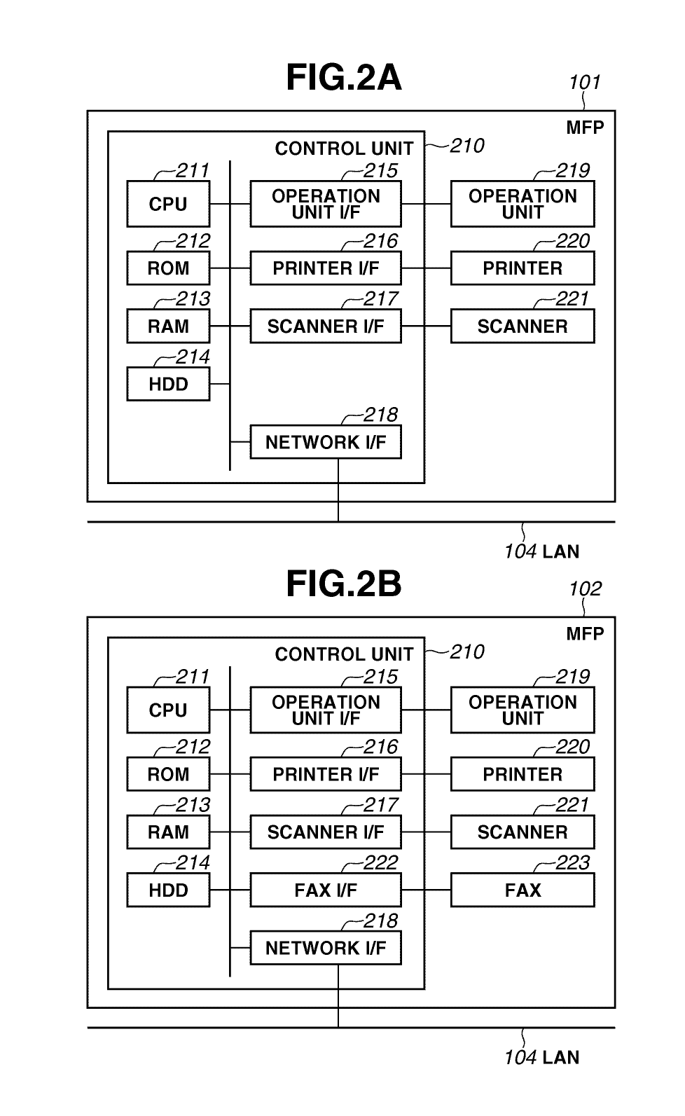

FIGS. 2A and 2B are block diagrams illustrating hardware configurations of the MFPs 101 and 102. The hardware configuration of the MFP 101 illustrated in FIG. 2A will be described below.

A control unit 210 including a central processing unit (CPU) 211 totally controls the MFP 101. The CPU 211 loads control programs stored in a read-only memory (ROM) 212 and a hard disk drive (HDD) 214 and then executes them to control the entire MFP 101. The ROM 212 stores information such as control programs for performing processing of the flowcharts described below. A random access memory (RAM) 213 is used as a main memory of the CPU 211 and a temporary storage area such as a work area. Similar to the ROM 212, the HDD 214 stores information such as control programs for performing processing of the flowcharts described below.

An operation unit interface (I/F) 215 connects an operation unit 219 to the control unit 210. The control unit I/F 215 outputs to the operation unit 219 screen information to be displayed thereon, and transmits to the CPU 211 information input from the operation unit 219 by a user. The operation unit 219 is provided with a display unit (liquid crystal display (LCD) unit having a touch panel function) and a keyboard.

The MFP 101 is provided with web browser functions. The web browser of the MFP 101 is capable of analyzing HTML data received from the web server 103, and displaying on an LCD unit of the operation unit 219 an operation screen based on descriptions of the received HTML data.

A printer I/F 216 connects a printer 220 to the control unit 210. The control unit 210 transmits to the printer 220 via the printer I/F 216 image data to be printed on the printer 220. Then, the printer 220 prints the image data on a recording media such as paper.

A scanner I/F 217 connects a scanner 221 to the control unit 210. The scanner 221 performs document scanning processing including scanning a document, generating image data, and transmitting the generated image data to the control unit 210 via the scanner I/F 217.

A network I/F 218 connects the control unit 210 (MFP 101) to the LAN 104. The network I/F 218 transmits and receives various information such as image data to/from an external apparatus (for example, the web server 103) on the LAN 104.

Then, the hardware configuration of the MFP 102 illustrated in FIG. 2B will be described below. With the MFP 102 illustrated in FIG. 2B, elements equivalent to those of the MFP 101 illustrated in FIG. 2A are assigned the same reference numerals and duplicated descriptions will be omitted.

A FAX I/F 222 connects a FAX 223 to the control unit 210. The FAX 223 performs FAX transmission processing for transmitting the image data generated in the document scanning processing by the scanner 221.

Unlike the MFP 101, the MFP 102 is further provided with a FAX function. In the present exemplary embodiment, the MFP 101 can use the FAX function of the MFP 102 via the web server 103. Specifically, the MFP 101 can transmit the image data generated in the document scanning processing by the scanner 221 of the MFP 101 to other apparatuses by using the FAX 223 of the MFP 102.

In the present exemplary embodiment, a processing form in which a plurality of apparatuses (the MFPs 101 and 102 in the present exemplary embodiment) cooperate to process a job is referred to as cooperative processing. The MFP 101 is referred to as an MFP as a cooperation source for the cooperative processing (a first information processing apparatus), and the MFP 102 is referred to as an MFP as a cooperation destination for the cooperative processing (a second information processing apparatus).

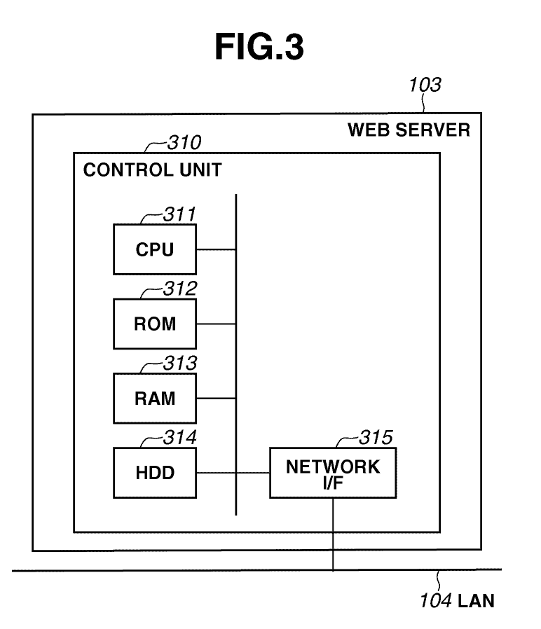

FIG. 3 is a block diagram illustrating a hardware configuration of the web server 103.

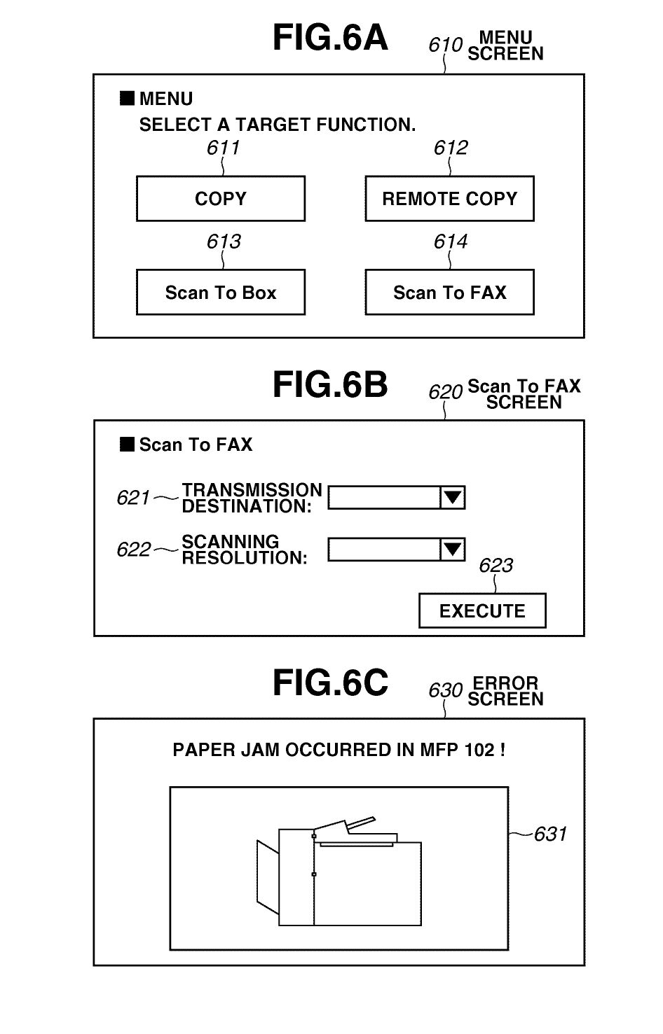

The control unit 310 including a CPU 311 totally controls the web server 103. The CPU 311 loads control programs stored in a ROM 312 and a HDD 314 and then executes them to perform various control processing. The ROM 312 stores information such as control programs for performing processing of the flowcharts described below, and a management list 600 illustrated in FIG. 6.

A RAM 313 is used as a main memory of the CPU 311 and a temporary storage area such as a work area. Similar to the ROM 312, the HDD 314 stores information such as control programs for performing processing of the flowcharts described below.

A network I/F 315 connects the control unit 310 to the LAN 104. The network I/F 315 transmits and receives various information to/from other apparatuses (for example, the MFPs 101 and 102) on the LAN 104.

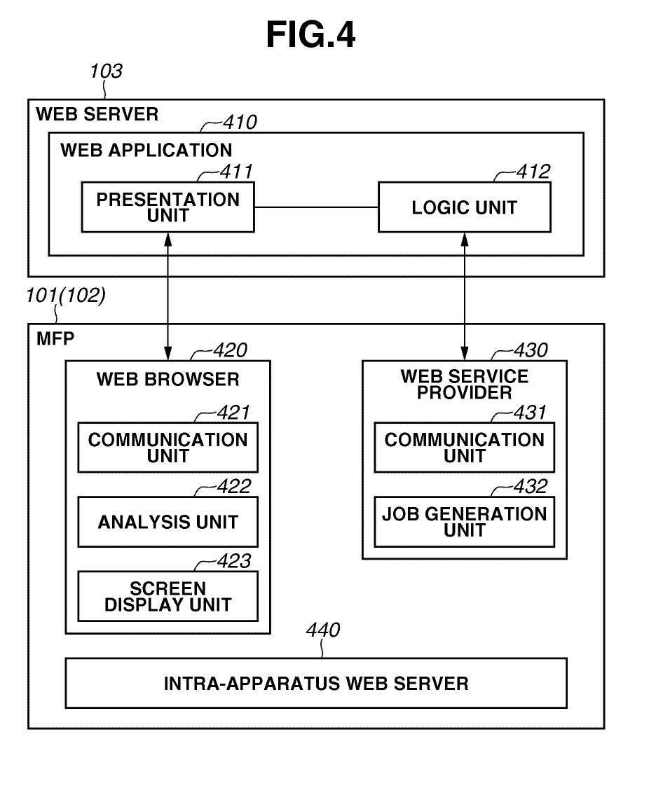

FIG. 4 illustrates a software configuration of the entire image processing system in the present exemplary embodiment. The software functions illustrated in FIG. 4 are achieved when the CPUs included in the MFP 101, the MFP 102, and the web server 103 illustrated in FIGS. 2A, 2B, and 3 execute control programs.

The MFP 101 includes a web browser 420, a web service provider 430, and an intra-apparatus web server 440. The MFP 102 is provided with the same software configuration as that of the MFP 101, and duplicated descriptions will be omitted.

The web browser 420 includes a communication unit 421, an analysis unit 422, and a screen display unit 423. The communication unit 421 communicates with a presentation unit 411 of the web application 410 via the network I/F 218 based on an HTTP protocol.

More specifically, the communication unit 421 requests the web application 410 for screen information (such as HTML data) for displaying a screen on the web browser 420, and receives relevant screen information from the presentation unit 411. The communication unit 421 also notifies the web application 410 of an instruction input via the operation screen by the user.

The analysis unit 422 analyzes the screen information received from the web application 410 by the communication unit 421. Based on the result of the analysis by the analysis unit 422, the screen display unit 423 displays the operation screen on the operation unit 219.

The web service provider 430 includes a communication unit 431 and a job generation unit 432. The web service provider 430 provides the web application 410 with web services by using specific hardware resources (for example, the printer 220 and the scanner 221) of the MFP 101.

The communication unit 431 receives from the web application 410 via the network I/F 218, based on the HTTP protocol, an instruction for executing any one of image processing functions provided by the MFP 101. The image processing functions provided by the MFP 101 include print processing by the printer 220, the document scanning processing by the scanner 221, and the FAX transmission processing by the FAX 223.

The job generation unit 432 generates a job for performing an image processing function indicated by the instruction received by the communication unit 431. A processing execution application (not illustrated) executes the job generated by the job generation unit 432.

The intra-apparatus web server 440 stores screen information for displaying an operation screen and Uniform Resource Locator (URL) information. Then, in response to a request from web browsers operating on other MFPs and PCs (not illustrated) on the LAN 104 based on HTTP protocol, the intra-apparatus web server 440 returns screen information as a response.

Then, a software configuration of the web server 103 will be described below. The web server 103 includes the web application 410 which includes the presentation unit 411 and a logic unit 412.

The presentation unit 411 communicates with the communication unit 421 of the web browser 420 via the network I/F 315. Specifically, in response to a request from the web browser 420, the presentation unit 411 generates screen information of an operation screen to be displayed on the web browser 420 and transmits the generated screen information to the web browser 420 via the network I/F 315. Alternatively, upon reception of a request for executing any one of the image processing functions provided by the MFP 101 or 102 input in the operation screen via the network I/F 315, the presentation unit 411 transfers the request to the logic unit 412.

The presentation unit 411 further performs redirection processing for changing a web page to be accessed by the MFP 101 or 102.

The logic unit 412 receives from the presentation unit 411 the request for executing any one of the image processing functions provided by the MFP 101 or 102. The logic unit 412 generates an instruction for instructing the MFP 101 or 102 to execute any one of the image processing functions. The logic unit 412 transmits the generated instruction to the web service provider 430 of the MFP 101 or 102 via the network I/F 315.

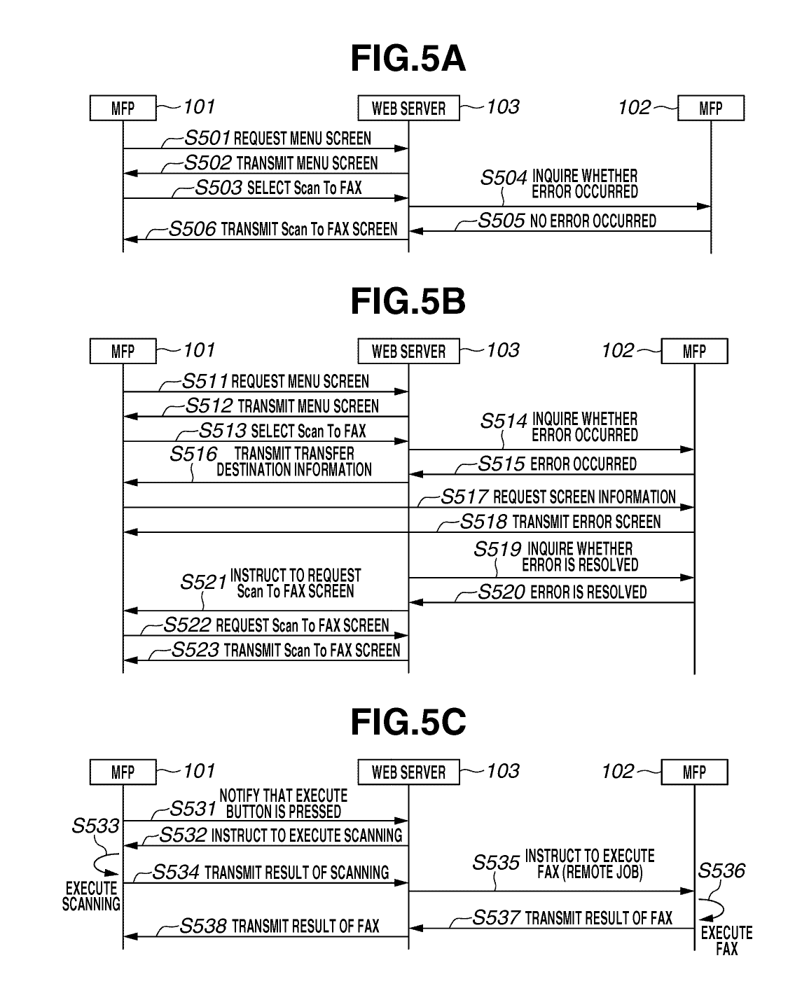

The cooperative processing performed by the MFPs 101 and 102 to process a job will be described below with reference to FIGS. 5A, 5B, 5C, 6A, 6B, 6C, and 7.

FIGS. 5A, 5B, and 5C are sequence diagrams illustrating processing performed among the MFP 101, the MFP 102, and the web server 103. Processing illustrated in FIG. 5A will be described below.

The user performs operations on the MFP 101. In step S501, based on an operation by the user, the web browser 420 of the MFP 101 requests the web application 410 of the web server 103 for a menu screen.

Upon reception of the request for the menu screen, the web application 410 generates screen information for displaying the requested menu screen. In step S502, the web application 410 transmits to the web browser 420 of the MFP 101 the generated screen information for displaying the menu screen.

Upon reception of the screen information transmitted in step S502, the web browser 420 of the MFP 101 displays the menu screen based on the relevant screen information. A menu screen 610 illustrated in FIG. 6A is an example of the menu screen displayed in this case.

The menu screen 610 displays a list of image processing functions available for the MFP 101. A COPY button 611 is used to activate copy processing in which the printer 220 of the MFP 101 performs printing based on image data generated in document scanning processing by the scanner 221.

A REMOTE COPY button 612 is used to activate the copy processing in which the printer 220 of other apparatuses (the MFP 102 in the present exemplary embodiment) performs printing based on image data generated in the document scanning processing by the scanner 221.

A Scan To Box button 613 is used to activate box storage processing in which image data generated in the document scanning processing by the scanner 221 is stored in the HDD 214 (box) of the MFP 101.

A Scan To FAX button 614 is used to activate the FAX transmission processing in which image data generated in the document scanning processing by the scanner 221 is transmitted by using the FAX function of other apparatuses (the MFP 102 in the present exemplary embodiment).

In the present exemplary embodiment, the REMOTE COPY button 612 and the Scan To FAX button 614 activate the cooperative processing. The web server 103 stores in the ROM 312 or HDD 314 information about image processing functions executable by each of the MFPs 101 and 102, and generates the menu screen 610 based on the information.

When the user presses the Scan To FAX button 614 in the menu screen 610, in step S503, the web browser 420 of the MFP 101 notifies the web application 410 that the Scan To FAX button 614 is pressed. Also when the user presses the REMOTE COPY button 612, the MFP 101, the MFP 102, and the web server 103 perform similar processing to the processing from step S503 on.

Upon reception of the notification, in step S504, the logic unit 412 of the web application 410 inquires the web service provider 430 of the cooperation destination, the MFP 102 for the cooperative processing whether an error has occurred.

Upon reception of the inquiry, the MFP 102 checks whether any error has occurred therein. When no error has occurred, in step S505, the MFP 102 notifies the web application 410 that no error has occurred.

Processing to be performed when some type of error has occurred in the MFP 102 will be described below with reference to FIG. 5B.

Upon reception of the notification that no error has occurred from the MFP 102, the web application 410 generates an operation screen for enabling the MFP 101 to perform the cooperative processing (the FAX transmission processing by using the FAX 223 of the MFP 102 in the present exemplary embodiment). In step S506, the web application 410 transmits the generated operation screen to the web browser 420 of the MFP 101.

Upon reception of the operation screen transmitted in step S506, the web browser 420 of the MFP 101 displays, for example, a Scan To FAX screen 620 illustrated in FIG. 6B.

In the Scan To FAX screen 620, the user makes necessary settings for the FAX transmission processing, such as a TRANSMISSION DESTINATION 621 and a SCANNING RESOLUTION 622 of a document. Then, when the user presses the EXECUTE button 623, the MFP 101 performs the FAX transmission processing by using the FAX 223 of the MFP 102

The sequence diagram illustrated in FIG. 5B will be described below.

Steps S511 to S514 (see FIG. 5B) are similar to steps S501 to S504 (see FIG. 5A), so that duplicated descriptions will be omitted.

Upon reception of the inquiry inquiring whether any error has occurred (step S514), the MFP 102 checks whether any error has occurred therein. If a paper jam occurs for example, in step S515, the MFP 102 notifies the web application 410 that a paper jam error has occurred. In this case, the MFP 102 also notifies the web application 410 of a URL indicating an error screen regarding the paper jam stored in the MFP 102.

In step S515, instead of notifying the web application 410 of any types of errors, the MFP 102 may notify the web application 410 of only errors affecting the cooperative processing.

Specifically, in step S514, the web server 103 notifies the MFP 102 of a function selected as cooperative processing together with the inquiry. If something is wrong with the FAX 223 upon reception of a notification that the Scan To FAX button 614 is pressed, for example, the MFP 102 notifies the web server 103 of the error occurrence.

If a paper jam error has occurred which does not affect the FAX transmission processing, the MFP 102 does not notify the web server 103 of the error occurrence.

This configuration notifies the user of only errors affecting the cooperative processing and does not notify the user of errors not affecting the cooperative processing, enabling the user to grasp only errors related to the user.

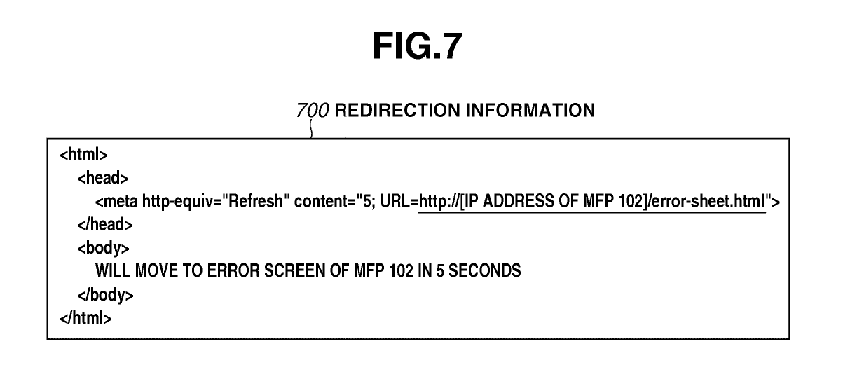

Returning to FIG. 5B, upon reception of such notification from the MFP 102, the web application 410 generates redirection information 700 (see FIG. 7) to transfer (redirect) an access destination of the MFP 101 from the web server 103 to the MFP 102.

A description <meta http-equiv=“Refresh” content=“5; URL=http://[IP ADDRESS OF MFP 102]/error-sheet.html”> in the redirection information 700 indicates that the access destination is to be redirected to the underlined URL in 5 seconds. The underlined URL is based on the URL notified from the MFP 102 in step S515.

In step S516, the web application 410 transmits the generated redirection information 700 to the web browser 420 of the MFP 101. In step S517, the web browser 420 of the MFP 101 accesses the intra-apparatus web server 440 of the MFP 102 based on the received redirection information 700.

Upon reception of such access from the MFP 101, in step S518, the intra-apparatus web server 440 of the MFP 102 transmits an error screen (error-sheet.html in the present exemplary embodiment) to the web browser 420 of the MFP 101 as a response.

An error screen 630 illustrated in FIG. 6C is an example of the error screen displayed in the web browser 420 of the MFP 101. In the error screen 630, a screen portion 631 displays detailed procedures for resolving an error by using diagrams and animations. The error screen 630 is displayed in consideration of a model of the MFP 102, installation status of options, and the type of error occurred.

As described with reference to FIG. 5A, the web server 103 provides the MFP 101 with operation screens for the cooperative processing in the information processing system according to the present exemplary embodiment. However, generating operation screens for the cooperative processing in consideration of the MFP model, the installation status of options, the type of error occurred, and other various factors may increase the load on the web server 103.

The present exemplary embodiment takes the increase in the load on the web server 103 into consideration. When a specific condition is satisfied, for example, when a certain type of error has occurred in the MFP 102, not the web server 103 but the MFP 102 provides the MFP 101 with operation screens related to the cooperative processing. Thus, the load on the web server 103 can be reduced.

Returning to FIG. 5B, in step S519, the web server 103 which transmitted the redirection information 700 to the MFP 101 (in step S516) periodically inquires the MFP 102 whether the error in the MFP 102 has been resolved.

When the error has been resolved in the MFP 102, in step S520, the MFP 102 notifies the web application 410 of such error resolution as a response to the inquiry.

Upon reception of the notification of the error resolution from the MFP 102, in step S521, the web application 410 instructs the web service provider 430 of the MFP 101 to request for screen information to display the Scan To FAX screen 620 on the web browser 420 of the MFP 101.

Upon reception of the instruction, the web service provider 430 instructs the web browser 420 to request for the screen information. In step S522, the web browser 420 requests the web application 410 for the screen information.

Upon reception of the request, the web application 410 generates a Scan To FAX screen 620. In step S523, the web application 410 transmits the generated Scan To FAX screen 620 to the web browser 420 of the MFP 101.

FIG. 5C is a sequence diagram illustrating processing performed among the MFP 101, the MFP 102, and the web server 103 when the Scan To FAX screen 620 is displayed on the MFP 101 and the user presses the EXECUTE button 623.

In step S531, the web browser 420 of the MFP 101 notifies the web application 410 that the EXECUTE button 623 is pressed.

Upon reception of the notification, the web application 410 generates an instruction for executing a relevant image processing function. In the present exemplary embodiment, to acquire image data for FAX transmission, the web application 410 generates an instruction for executing the document scanning processing by using the scanner 221. In step S532, the web application 410 transmits the generated instruction for the document scanning processing to the web service provider 430 of the MFP 101.

Upon reception of the instruction, in step S533, the MFP 101 performs the document scanning processing by using the scanner 221 based on the received instruction. Upon completion of the document scanning processing, in step S534, the web service provider 430 of the MFP 101 transmits the image data generated in the document scanning processing to the web application 410.

Upon reception of the image data transmitted in step S534, the web application 410 generates an instruction for performing the FAX transmission processing. In step S535, the web application 410 transmits the generated instruction to the web service provider 430 of the MFP 102.

Upon reception of the instruction, in step S536, the MFP 102 performs the FAX transmission processing by using the FAX 223 based on the received instruction.

Upon completion of the FAX transmission processing, in step S537, the web service provider 430 of the MFP 102 notifies the web application 410 of the completion of the FAX transmission processing. In step S538, the web application 410 notifies the web service provider 430 of the MFP 101 of the completion of the FAX transmission processing.

As described above, in the information processing system according to the present exemplary embodiment, the MFPs 101 and 102 can perform image processing functions based on an instruction generated by the web server 103.

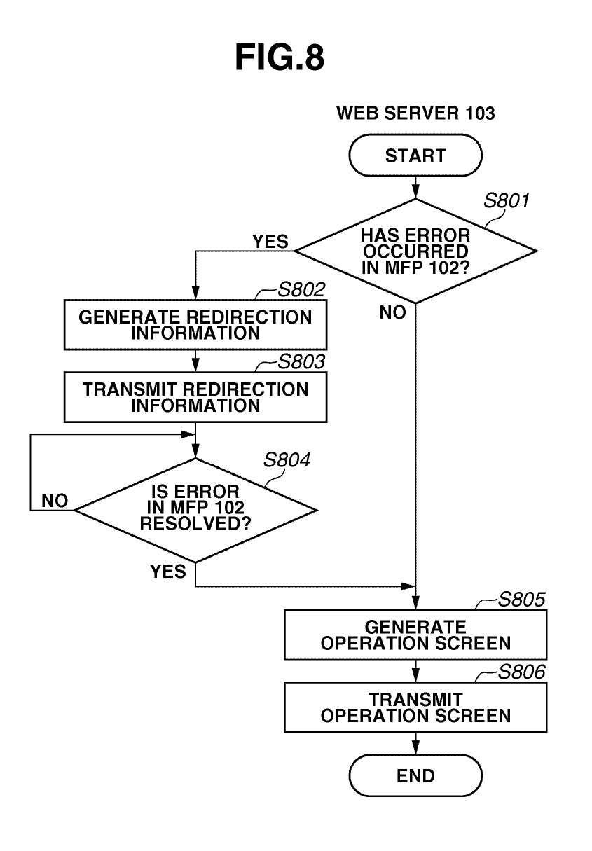

Processing illustrated in FIG. 8 will be described below. FIG. 8 is a flowchart illustrating processing performed by the web server 103 when it receives from the MFP 101 a request for an operation screen related to the cooperative processing (for example, in step S503 (see FIG. 5A)).

Steps S801 to S806 are implemented when the CPU 311 included in the web server 103 loads a relevant program from the ROM 312 into the RAM 313 and then executes it.

In step S801, the web server 103 determines whether an error has occurred in the MFP 102 as a cooperation destination for the cooperative processing. Based on the result of the determination, the web server 103 further determines which of the web server 103 and the MFP 102 is to provide the MFP 101 with the operation screen related to the cooperative processing.

Specifically, the web server 103 inquires the MFP 102 whether an error has occurred therein. When the web server 103 receives from the MFP 102 a response indicating that an error such as a paper jam has occurred therein (YES in step S801), the web server 103 determines that the MFP 102 is to provide the MFP 101 with the operation screen related to the cooperative processing, and the processing proceeds to step S802.

On the other hand, when the web server 103 receives from the MFP 102 a response indicating that no error has occurred (NO in step S801), the web server 103 determines that the web server 103 itself is to provide the MFP 101 with the operation screen related to the cooperative processing, and the processing proceeds to step S805.

In step S802, the web server 103 generates redirection information, for example the redirection information 700 (see FIG. 7), to redirect the access destination of the MFP 101 from the web server 103 to the MFP 102. In step S803, the web server 103 transmits the generated redirection information to the MFP 101.

In step S804, the web server 103 determines whether the error has been resolved in the MFP 102.

Specifically, when the web server 103 receives from the MFP 102 a notification of the error resolution (YES in step S804), the web server 103 determines that the error has been resolved in the MFP 102, and instructs the web service provider 430 of the MFP 101 to request for screen information as illustrated in step S521 (see FIG. 5B). On the other hand, when the web server 103 does not receive from the MFP 102 a notification of the error resolution (NO in step S804), the web server 103 waits until the relevant notification is received.

In step S805, in response to the request from the MFP 101, the web server 103 generates an operation screen related to the cooperative processing such as the Scan To FAX screen 620 (see FIG. 6). In step S806, the web server 103 transmits the generated operation screen to the MFP 101 (first transmission unit).

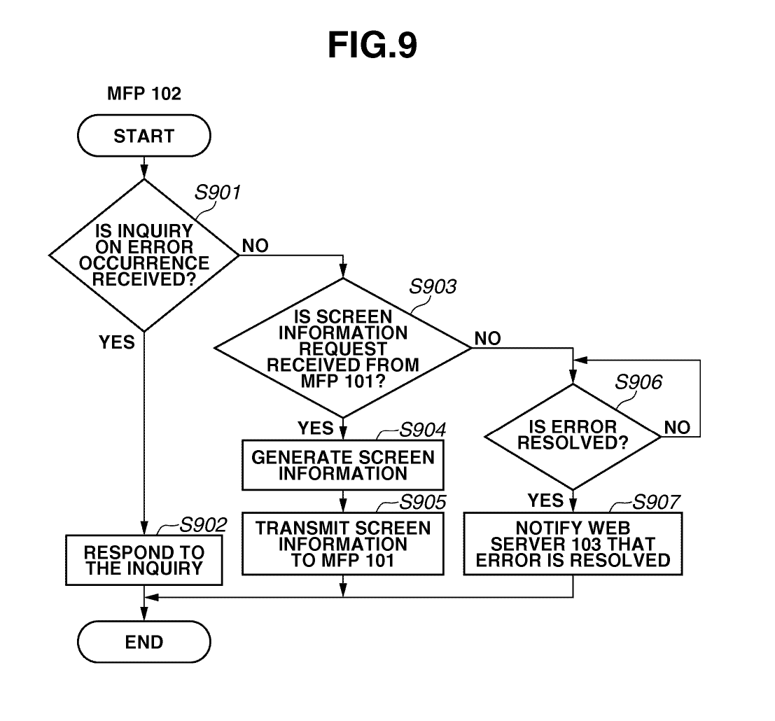

Processing illustrated in FIG. 9 will be described below. FIG. 9 is a flowchart illustrating processing performed by the MFP 102 as a cooperation destination for the cooperative processing.

Steps S901 to S907 are implemented when the CPU 211 included in the MFP 102 loads a relevant program from the ROM 212 into the RAM 213 and then executes it.

In step S901, the MFP 102 determines whether an inquiry inquiring whether an error has occurred is received from the web server 103. When the MFP 102 receives the inquiry from the web server 103 (YES in step S901), the processing proceeds to step S902. In step S902, the MFP 102 responds to the inquiry inquiring whether an error has occurred.

When the MFP 102 responds to the inquiry that an error has occurred, the MFP 102 also notifies the web server 103 of a URL indicating an error screen related to the error. On the other hand, when the MFP 102 does not receive the inquiry from the web server 103 (NO in step S901), the processing proceeds to step S903.

Instep S903, the MFP 102 determines whether a request for an error screen related to the cooperative processing is received from the MFP 101 as a cooperation source. When the MFP 102 receives the request for the error screen from the MFP 101 (YES in step 903), the processing proceeds to step S904. In step S904, the MFP 102 generates an error screen such as the error screen 630 (see FIG. 6) as an operation screen related to the cooperative processing.

In step S905, the MFP 102 transmits the generated error screen to the MFP 101 (second transmission unit). On the other hand, when the MFP 102 does not receive the request for an error screen from the MFP 101 (NO in step S903), the processing proceeds to step S906.

In step S906, the MFP 102 receives from the web server 103 an inquiry inquiring whether an error such as a paper jam error has been resolved, and determines whether an error occurred therein, such as a paper jam error, has been resolved.

When the error has been resolved, for example, through user maintenance (YES in step S906), the processing proceeds to step S907. In step S907, the MFP 102 notifies the web server 103 of the error resolution as a response to the inquiry. On the other hand, when the error has not been resolved (NO in step S906), the web server 103 waits until the error resolves.

Although, in the present exemplary embodiment, the MFP 102 notifies the web server 103 of the error resolution as a response to the inquiry, the present invention is not limited thereto. For example, the MFP 102 maybe provided with software or hardware (not illustrated) for notifying the web server 103 of the error resolution without receiving an inquiry therefrom.

As mentioned above, according to the present exemplary embodiment, when a specific condition is satisfied, when a certain type of error has occurred in the MFP 102, not the web server 103 but the MFP 102 generates an operation screen related to the cooperative processing and provides the MFP 101 with the operation screen. Thus, the load on the web server 103 can be reduced.

If the web server 103 also generates an error screen related to an error occurring in the MFP 102, the web server 103 needs to take into consideration various factors such as the model of the MFP 102, the installation status of options, and the type of error occurred. This may increase the load on the web server 103.

Although, in the present exemplary embodiment, only two MFPs (MFPs 101 and 102) are mentioned, a hundred MFPs or several hundreds of MFPs may naturally be capable of communicate with the web server 103. In this case, the load on the web server 103 may increase to a remarkable extent. The present exemplary embodiment solves this issue.

If the web server 103 generates a general-purpose error screen common to all of MFPs, the load on the web server 103 can be reduced. However, unlike the present exemplary embodiment, this configuration cannot display detailed procedures for resolving an error in consideration of the MFP model, the installation status of options, and the type of error occurred.

On the other hand, the configuration according to the present exemplary embodiment enables displaying detailed procedures for resolving an error since the MFP as a cooperation destination for the cooperative processing generates an error screen.

Although, in the present exemplary embodiment, the web server 103 inquires the MFP 102 whether an error has occurred therein in step S801 (see FIG. 8), the processing is not limited thereto, and the following configuration may be applied. Specifically, if a certain type of error has occurred in the MFP 102, the MFP 102 notifies the web server 103 of the error occurrence, and the web server 103 stores the notification. Upon reception of a request for an operation screen related to the cooperative processing from the MFP 101, the web server 103 determines, based on information stored therein, whether an error has occurred in the MFP 102.

In the first exemplary embodiment, if a certain type of error has occurred in the MFP 102 as a cooperation destination for the cooperative processing as a specific condition, not the web server 103 but the MFP 102 provides the MFP 101 with an operation screen related to the cooperative processing (error screen).

However, the present invention is not limited thereto. For example, when a specific function is used as cooperative processing, not the web server 103 but the MFP 102 may provide the MFP 101 with an operation screen related to the cooperative processing. In the present exemplary embodiment, this configuration will be described below.

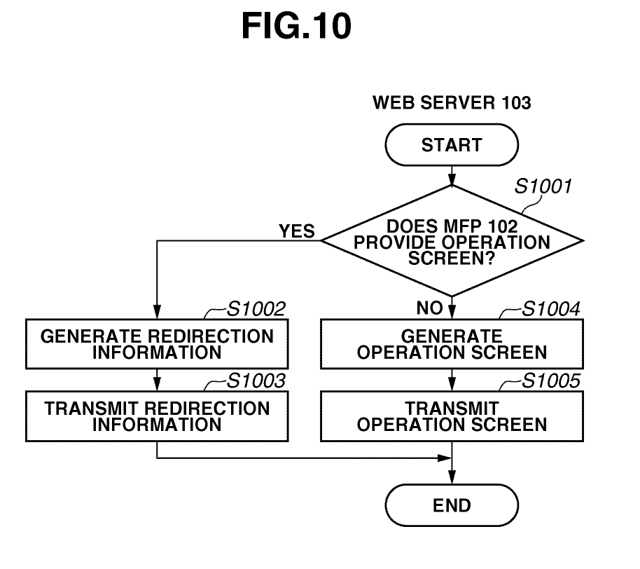

FIG. 10 is a flowchart illustrating processing performed by the web server 103 in the present exemplary embodiment. Steps S1001 to S1005 are implemented when the CPU 311 included in the web server 103 loads a relevant program from the ROM 312 into the RAM 313 and then executes it.

Suppose that the menu screen 610 illustrated in FIG. 6 is displayed on the web browser 420 of the MFP 101, and that the user presses either the REMOTE COPY button 612 or the Scan To FAX button 614 to perform the cooperative processing.

In step S1001, the web server 103 determines whether the MFP 102, not the web server 103, is to provide an operation screen related to the cooperative processing. Specifically, the web server 103 inquires the MFP 102 whether the MFP 102 can provide an operation screen related to the cooperative processing selected in the menu screen 610.

Then, when the web server 103 receives from the MFP 102 a response that the MFP 102 can provide the operation screen related to the cooperative processing (YES in step S1001), the web server 103 determines that the MFP 102 is to provide the operation screen related to the cooperative processing, and the processing proceeds to step S1002.

On the other hand, when the web server 103 receives from the MFP 102 a response that the MFP 102 cannot provide the operation screen related to the cooperative processing (NO in step S1001), the web server 103 determines that the web server 103 is to provide the operation screen related to the cooperative processing, and the processing proceeds to step S1004.

In the present exemplary embodiment, when performing repeat copy processing as cooperative processing, the MFP 102 responds that it can provide an operation screen. When performing Scan To FAX processing as cooperative processing, the MFP 102 responds that it cannot provide an operation screen.

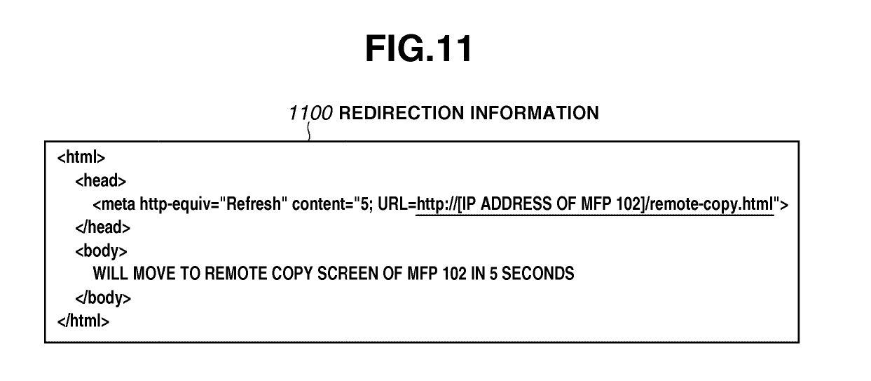

In step S1002, to redirect the access destination of the MFP 101 from the web server 103 to the MFP 102, the web server 103 generates, for example, the redirection information illustrated in FIG. 11.

In step S1003, the web server 103 transmits the generated redirection information to the MFP 101, and the processing exits this flowchart.

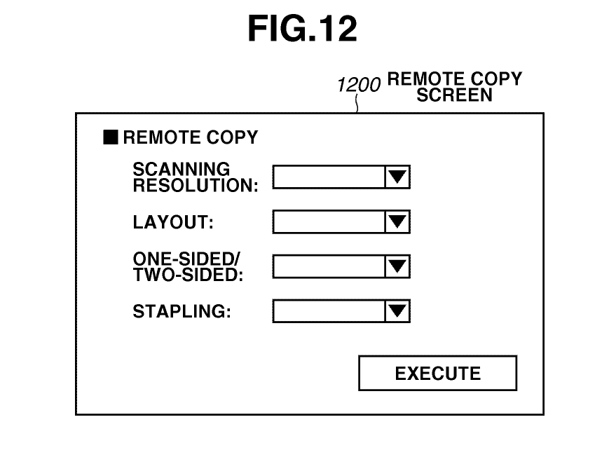

A remote copy screen 1200 illustrated in FIG. 12 is an example of an operation screen displayed on the web browser 420 of the redirected MFP 101. The remote copy screen 1200 is an operation screen provided by the MFP 102 as a cooperation destination for the cooperative processing to the MFP 101. As settings related to the output destination (MFP 102), the remote copy screen 1200 displays a layout setting for performing “2 in 1” and “4 in 1” printing, a one-sided/two-sided setting, and post-print processing such as stapling processing.

Processing instep S1004 will be described below. In step S1004, in response to the request from the MFP 101, the web server 103 generates an operation screen related to the cooperative processing such as the Scan To FAX screen 620 illustrated in FIG. 6.

In step S1005, the web server 103 transmits the generated operation screen to the MFP 101, and the processing exits this flowchart.

As mentioned above, according to the present exemplary embodiment, when an operation screen having different setting items depending on the model of the MFP 102 and option installation status, such as the remote copy screen 1200, is requested, not the web server 103 but the MFP 102 provides the MFP 101 with the operation screen related to the cooperative processing. Thus, the load on the web server 103 can be reduced.

Aspects of the present invention can also be realized by a computer of a system or apparatus (or devices such as a CPU or MPU) that reads out and executes a program recorded on a memory device (computer-readable medium) to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-098527 filed Apr. 26, 2011, which is hereby incorporated by reference herein in its entirety.

What is claimed is:

1. An information processing system comprising:
a server apparatus;
a first information processing apparatus; and
a second information processing apparatus,
wherein the first and the second information processing apparatuses cooperate with each other to achieve cooperative processing for processing a job,
wherein the server apparatus comprises a first transmission unit configured to transmit an operation screen related to the cooperative processing to the first information processing apparatus,
wherein the second information processing apparatus comprises a second transmission unit configured to transmit an operation screen related to the cooperative processing to the first information processing apparatus, and
wherein the server apparatus further comprises a determination unit configured to, when the server apparatus receives a request for the operation screen related to the cooperative processing from the first information processing apparatus, determine which of the server apparatus and the second information processing apparatus is to transmit the operation screen related to the cooperative processing to the first information processing apparatus, by making an inquiry to the second information processing apparatus.

2. The information processing system according to claim 1, wherein, when the determination unit determines that the second information processing apparatus is to transmit the operation screen related to the cooperative processing to the first information processing apparatus, an access destination of the first information processing apparatus is redirected from the server apparatus to the second information processing apparatus.

3. The information processing system according to claim 2, wherein the first transmission unit transmits to the first information processing apparatus information for redirecting the access destination of the first information processing apparatus from the server apparatus to the second information processing apparatus.

4. The information processing system according to claim 1, wherein, when an error has occurred in the second information processing apparatus, the determination unit determines that the second information processing apparatus is to transmit the operation screen related to the cooperative processing to the first information processing apparatus.

5. The information processing system according to claim 1, wherein, when a specific function is used as the cooperative processing, the determination unit determines that the second information processing apparatus is to transmit the operation screen related to the cooperative processing to the first information processing apparatus.

6. The information processing system according to claim 1, wherein, when the second information processing apparatus is able to provide the first information processing apparatus with the operation screen related to the cooperative processing, the determination unit determines that the second information processing apparatus is to transmit the operation screen related to the cooperative processing to the first information processing apparatus.

7. The information processing system according to claim 1,
wherein the server apparatus further comprises a generation unit configured to generate an instruction for instructing execution of the cooperative processing based on an operation by a user on the first information processing apparatus, and
wherein, based on the instruction, the first and the second information processing apparatuses perform the cooperative processing.

8. The information processing system according to claim 1, wherein the cooperative processing includes transmission processing in which the second information processing apparatus transmits, to another apparatus, image data generated by the first information processing apparatus reading a document.

9. The information processing system according to claim 1, wherein the cooperative processing includes print processing in which the second information processing apparatus prints image data generated by the first information processing apparatus reading a document.
